(19) United States
(12) Patent Application Publication
(10) Pub. No.: US 2018/0101277 A9
(43) Pub. Date: Apr. 12, 2018

(54) Skin Touchpad

(71) Applicant: Evan John Kaye, Short Hills, NJ (US)

(72) Inventor: Evan John Kaye, Short Hills, NJ (US)

(21) Appl. No.: 14/864,845

(22) Filed: Sep. 24, 2015

Related U.S. Application Data
(60) Provisional application No. 62/054,574, filed on Sep. 24, 2014.

(51) Int. Cl. G06F 3/042; G06F 1/16; G06F 3/041

(52) U.S. Cl. CPC G06F 3/0425; G06F 3/0416; G06F 1/163

(57) ABSTRACT

The invention provides a method to turn the user's skin into a touchpad device. In the case of a wearable electronic device this can be accomplished by using one or more cameras which face the area of the user's skin that will be used as a touchpad. These cameras can be conveniently embedded into the wearable device. Through use of the cameras, and image processing, it is possible to track the finger movement of at least one finger. It is also possible to determine where on skin touchpad area the finger is hovering and when it is touching the surface. It is also possible to make a determination of how hard the user is pressing on the touchpad area.

### RELATED U.S. APPLICATION DATA

This is the non-provisional application of provisional application No. 62/054,574 filed on Sep. 24, 2014.

### FIELD OF THE INVENTION

The invention relates to a way that human skin can be used as a touchpad so as to effectively serve as an input device to a machine.

### BACKGROUND OF THE INVENTION

Touchpads have been commercialized since the 1980's as away for users to input cursor movements. They are often used as a substitute for a mouse where desk space is limited, and have become a common feature of laptop computers. More recently, touchscreens on personal digital assistant devices, or on phones have become a popular way to accept user inputs into a smartphone and similar devices Some touchscreens can detect and discern multiple touches simultaneously, while others can only detect a single touch point. Some systems are also capable of sensing or estimating the amount of pressure that is being applied to the screen. Sometimes, particularly on small screens such as a watch with a touchscreen, the area for touch input is so small that it limits the effectiveness of a user's input. In these cases, the finger oftentimes will hide the underlying object the user is selecting so that they cannot select something small with accuracy. As a result the icons on the screen cannot be miniaturized and very few objects can be displayed on the screen for selection at any one time. What is needed is a way for someone to select something on the screen with a high degree of precision. One way to accomplish this would be through the use of a stylus, which has been used for some devices in the past, but it is not convenient to detach a stylus from the devices, or o carry a stylus around for the purpose of intermittently selecting objects on the screen of a device. The most convenient way is to use one's fingers.

### SUMMARY OF THE INVENTION

What is needed in the art and not previously described is a way to turn the user's skin into a touchpad device. In the case of a wearable electronic device this can be accomplished by using one or more cameras which face the area of the user's skin that will be used as a touchpad. These cameras can be conveniently embedded into the wearable device. Through use of the cameras, and image processing, it is possible to track the finger movement of at least one finger. It is also possible to determine where on skin touchpad area the finger is hovering and when it is touching the surface. It is also possible to make a determination of how hard the user is pressing on the touchpad area.

### DESCRIPTION OF THE FIGURES

FIG. 1 shows a watch with two cameras and a light source that are facing the dorsal surface of the user's hand.

FIG. 2A shows the view of a camera that is tracking a pointing finger along a surface with the finger making contact with the surface nearby the camera.

FIG. 2B shows the view of a camera that is tracking a pointing finger along a surface with the finger hovering above the surface far from the camera.

### DETAILED DESCRIPTION OF THE PREFERRED EMBODIMENT

The invention is described in detail with particular reference to a certain preferred embodiment, but within the spirit and scope of the invention, it is not limited to such an embodiment. It will be apparent to those of skill in the art that various features, variations, and modifications can be included or excluded, within the limits defined by the claims and the requirements of a particular use.

One embodiment of the invention is the transformation of the dorsal surface of a person's hand into a touchpad so that it can be used as an input device into a watch. The hand that is distal to the wrist having the watch on it is turned into the touchpad. More specifically, the dorsal surface of the hand is used as the touchpad. This allows the user to look at the screen of the watch in the conventional way while providing input to the watch by touching the dorsal surface of the hand with their other hand's fingers. As most people wear their watch on their non-dominant hand's wrist, it is natural for them to point with their dominant hand on the dorsal surface of the non-dominant hand.

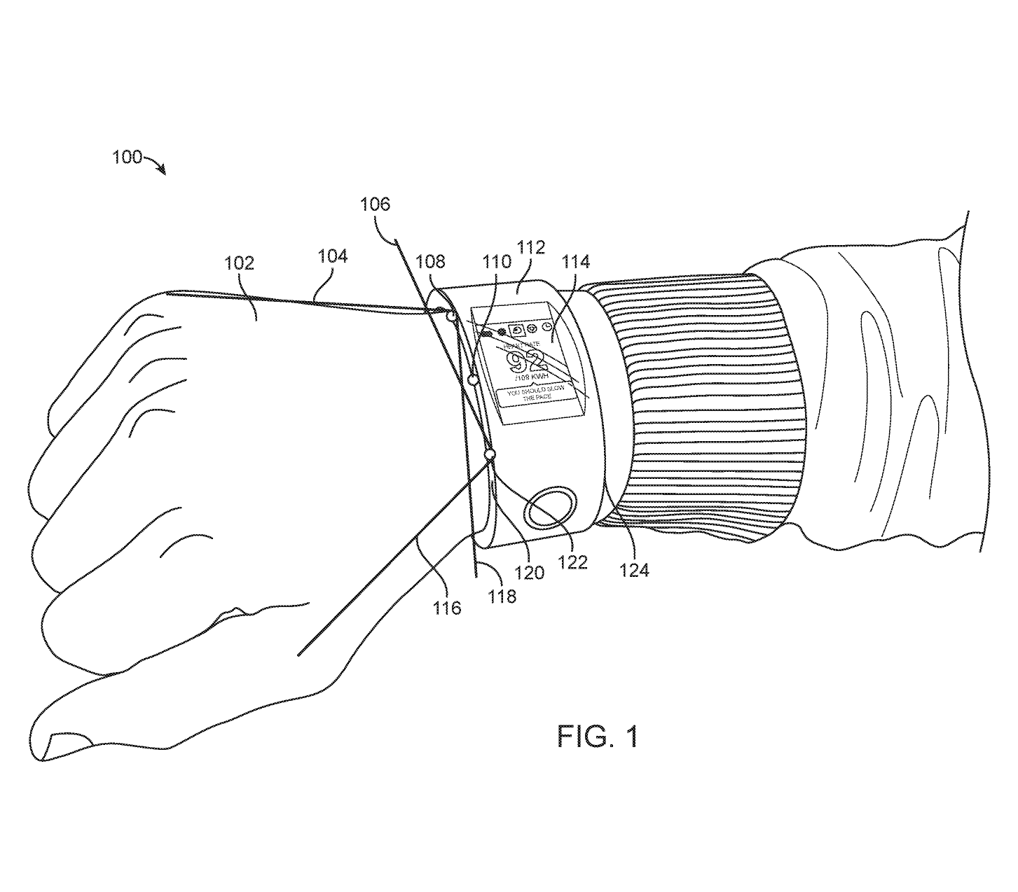

With reference now to FIG. 1, a photograph 100 is shown with a watch 112 on a person's right wrist. This configuration is typical of a left-handed person. The dorsal surface 102 of the person's right hand is shown. The watch 112 has a screen 114, a proximal edge 124 and a distal edge 120. There are two cameras incorporated into the distal edge 120 of the watch 112. For clarity they will be referenced by the forearm bones that they are situated on top of. The ulnar camera 108 is shown with its field of view bounded on the right 104 and on the left 118, and the radial camera 118 with its field of view bounded on the right 106 and on the left 116. There is also alight source 110 that is also incorporated into the distal edge 120 of the watch 112. This light source may be a LED that generates light in the visible spectrum or non-visible spectrum (e.g. ultraviolet spectrum), whatever is used needs to be compatible with the capabilities of the cameras 108 and 122. Concave lenses are used to give the cameras a wide field of view. This is important to maximize the region of the dorsal surface 102 that is being tracked, and also to maximize the change in size of a pointing finger when it moves from near the camera to further away. In some configurations there may be no need to have a light source, but the lack of a light source 110 would limit the utility, sensitivity and accuracy of the skin touchpad in dark areas. Since the wrist can be extended or flexed, the angle at which the cameras 108/122 and light source 110 would need to detect and illuminate the surface would require some range so as to accommodate a range of wrist movement around the neutral position. The touch surface need not operate at significant flexion or extension of the wrist.

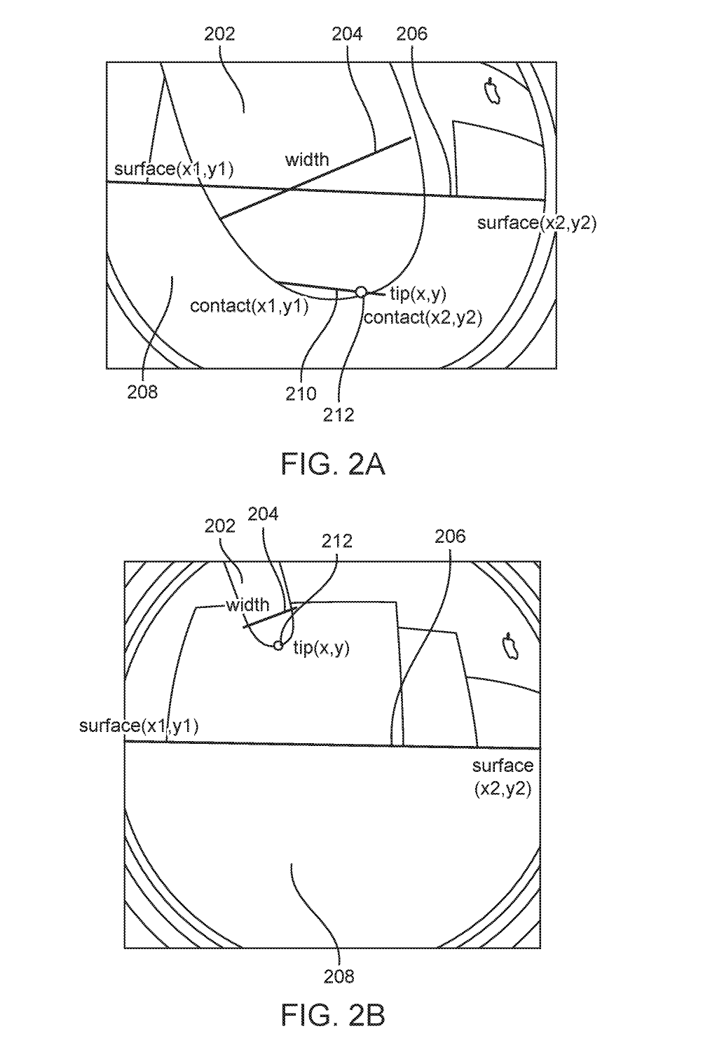

With reference now to FIG. 2A and FIG. 2B, the views of a camera is shown that is tracking the movement of a finger 202 on a flat surface 208. The finger is isolated by using standard image processing filters and techniques that are known by those with skill in the art. Some filters may include threshold skin color, edge detection, template matching, and contour detection. Some calibration may be required to achieve optimal results. Once the finger 202 is isolated in the video input stream and can be tracked on a frame by frame basis, then the finger width 204 is monitored. The fingertip 212 is tracked as coordinates (x,y). There may also be a degree of confidence in the tip position and all measurements described such that only when a threshold confidence is met then an action occurs. The surface horizon 206 is also monitored. The surface horizon 206 is approximated as a straight line from the left side of the image (x1,y1) to the right side of the image (x2,y2), The average height of the horizon from the bottom of the frame is (y1+y2)/2, and the angle of the horizon from the horizontal can also be calculated (if coordinates are calculated from bottom left). The finger width 204 may be determined by using a fixed angle from the surface angle 206 and a determining the region of the finger 202 with the maximum width at that determined angle. Or the finger width 204 may be determined by another method that approximates the width of the finger in pixels in a perpendicular plane to the longitudinal axis of the finger. The contact line 210 of FIG. 2A is missing in FIG. 2B because no contact with the surface is present, The contact line 210 can be determined by tracking one or more factors including: (1) distortion in the smooth contour of the finger profile; (2) shadow below the finger and on the surface; (3) depression of the surface; (4) the degree to which the finger is calculated to be in contact with the surface given the finger width 204, the aforementioned average height of the horizon in the image, and the fingertip position 212.

Using the above inputs it is possible to calibrate the finger width 204 and fingertip 212 position for four reference coordinates on the dorsal side of the hand (top left, top right, bottom left, bottom right). Any combination of finger width and tip position would allow us to compute the position of the finger on the dorsal surface of the hand. Depending on the concavity and field of view of the lens the finger width would be converted into a computed distance from the camera. The computed distance be a non-linear function of the finger width 204 as mathematically computed by those with skill in the art, The estimated hovering height over the surface would be similarly computed. All the above can be achieved with the use of a single camera. The introduction of a second camera, as in FIG. 1 allows the stereoscopic nature of the apparatus to have increased fidelity in determining the exact position of the finger on the surface. More than two cameras can also be used to improve the resolution. The shadow casted by the finger obscuring the light source can also be used to determine the location of the finger on the surface if it is tracked by cameras that are sufficiently far away from the light source. Laser grids that are projected onto the surface and fingers may also be used to determine the precise locations and contours of the surface and fingers. The use of multiple cameras are particularly helpful in determining the position of more than one fingers touching the surface simultaneously.

Since the tapping of a discrete point on the dorsal surface of the hand would result in a vibration to the watch on the wrist, the accelerometer in a smart watch can be used to augment the detection of a tap. Since most times the hand would not be stabilized on a desk, the tap would also result in a brief shift of the field of view beyond the surface horizon 206. Tracking changes in the objects beyond the horizon, in terms of sudden shifts in the vertical plane, in conjunction with a sudden movement down of the finger would be indicative of a tap of the dorsal surface of the hand and can be used to augment the touch detection process.

Since we can track the touch and position of a finger moving around the dorsal surface of the hand as described above, we can determine more sophisticated touch patterns, such as swipes, taps, and types of pinches or zooms (when two fingers are used) as has become convention by users of touchscreen smart phones. It is also possible to determine when someone is using their finger to trace a letter of the alphabet, number, or another symbol. In this way, someone can use the surface of their hand to input keyboard type entries into their smart phone which otherwise does not have an efficient means to accept such entries.

The methodology described above provides for detection of the position of a finger over the dorsal hand surface before it makes contact with the surface. It is possible, therefore, to have a cursor display on the smart phone screen showing the position of a hover. Only when a tap on the skin surface is made does the cursor essentially “click” the underlying desktop or application at that “mouse” position as has become commonplace in graphical user interface software applications. Even if the skin surface touchpad is not used, a multiple front-facing camera configuration on a smart-phone may track the fingertip hovering above the device in a similar way so as to provide an onscreen cursor and only activate the control on the screen when a sudden movement in the vertical plane down to the device is made. In this mode, the actual place touched on the screen less relevant than that position of the cursor. Using this method a tiny onscreen keyboard can be displayed and typed on.

There may also be a projector built into the smart watch which shines controls on the skin surface. It would be most effective if surface mapping was dynamically performed using the cameras in real-time to determine the exact location of the skin surface and the digital image of the controls being projected would be distorted accordingly so that it was optimally reflected from the skin surface which is not flat and can be at various angles to the smart watch as described above. As eyewear with built in cameras and wireless communication devices are becoming more commonplace, it is possible to use the image from the camera eyewear to augment or be the sole input of visual data to determine finger position over the dorsal surface of a hand or any other part of the body. Touch detection as opposed to hovering would be more difficult to discern from the angle of the glasses, but the touch events can be determined by accelerometer or another means (such as shadow detection around the depressed area of the skin). The raw images can be transmitted to the smart phone, or the image processing may be done on the glasses, or on another device, but the result would be coordinates of a finger over a skin surface which are relayed to an electronic device where specific inputs can determined. Small projectors built into the eyewear may also project controls to be manipulated by the user on skin in a dynamic way by tracking the body part where the projection should land. Surface imaging mapping would allow the projected image to be manipulated in real-time so that it gives the appearance of being static on the skin surface regardless of orientation. One limitation of a single projector on eyewear is the shadow that would result from the finger over the controls. Since the projector would be in close proximity to the eyes, the amount of shadow should not be too distracting for the using. Using multiple projectors on the eyewear would decrease the amount of shadow. The image reflecting off the user's finger back into their eye would, however, be distracting. Therefore the finger should be tracked and the part of the image that the finger is expected to reflect should be removed and a black mask should be projected instead. That way the finger will not be illuminated and it will offer a better experience for the user. Another way to deal with the problem of the shadow is to provide a cursor in the projected area such that it maps the movements of the finger, but the finger would be outside the immediate region of the cursor. The finger might even be “extended” visually, and could have a thinner region extending from it in the same orientation that it is in reality, but allow a user to select small objects in the view.

If no smart glasses are present it is still possible to use a camera on the wrist to obtain the point of view of a camera on the head through use of the corneal reflection of what is being seen by the user. As miniature cameras are now achieving higher resolution, focus capabilities, and low light sensitivity, it is possible to start using front-facing cameras on electronic devices to study the corneal reflection of the user. One or more front-facing cameras may be used. The known underlying iris pattern is subtracted out of the image in real-time (this may require some calibration to photograph the iris pattern in each eye). Once the iris pattern is subtracted and the size of the pupil is accounted for in this subtraction (which may also need some calibration to get the iris pattern and various degrees of ambient light), then the view that the person is seeing can be determined, Using this view is possible to determine where the finger is oriented over the surface of the skin, or any surface. For instance, using a non-touch screen and a webcam on a desktop, two rectangles can be shown on the screen. One rectangle is red and the other is green. Using the input solely from the webcam it is possible to determine whether someone is holding their hand over the green block or the red block by determining which remaining block can still be seen in the corneal reflection of the user. In this simple case it is not even necessary to digitally subtract and account for underlying iris color, but when the distance is increase and the object size is smaller, then those digital subtractions substantially improve the resolution.

Another way to improve the resolution of the skin touch surface is through the use of transcutaneous electric signals. Using electrodes it is possible to send digital signals across the skin. Using an electric signal generator on the pointing hand (for example in a ring on the index finger) the signal can pass through electrodes on the ring across the skin surface and be transferred to the dorsal surface of the other hand. Multiple electrodes in the wrist strap of a smart watch or some other wearable in the other arm would allow for the detection and triangulation of those signals to determine the position of touch. Since the electrodes in the strap of a watch does not surround the touch surface, it would require more than three and many calibration points to determine the amplitude and delay of the signals across the electrodes. The frequency of the signals should also be sufficiently low so as not to confuse the beacon signals. No timing information needs to be encoded in the signals so long as the frequency of the signals is sufficiently low (e.g. once every 500 ms).

Our bodies produce bioelectric signals, and the EKG signals can also be used to determine whether a touch event is taking place. If an electrode and detection apparatus is sensitive enough it could determine just using the wrist strap as an electrode position if another extremity is touching the one that the watch is on. It would be difficult to triangulate and get the precise location of the touch, but the touch event could be discerned and aid in the resolution of the aforementioned touch events.

If no projected image is used, a washable, removable, or permanent tattoos may be used on the skin as controls that can be touched for input into an electronic device. The tattoos would not have any pressure sensitive detection properties but one or more cameras would be used to determine touch position as described above.

While the hand has been used for the touch surface in the preferred embodiment, any part of the skin surface, or person's surface with clothing can be used. A natural place for the smart watch is also proximal to the watch on the forearm. While this provides more area for touch and manipulation, it may not always be readily accessible under clothing the way the dorsal hand surface is.

I claim:

1. A method of enabling a user's finger to serve as an input device comprising:
at least one camera positioned to film the user's finger and a skin surface; and
an image processing algorithm to determine the position of the finger as it relates to the skin surface.

2. The method of claim 1 wherein the skin surface is the dorsal aspect of the hand and at least one camera is embedded in a watch.

3. The method of claim 1 wherein the skin surface is the palmar aspect of the hand and at least one camera is embedded in a watch strap.

4. The method of claim 1 wherein the image processing algorithm uses the size of

5. The method of claim 4 wherein the image processing algorithm uses a plurality of camera inputs to determine the location of the finger.

6. A method of using an accelerometer and a video input to determine when ser has tapped their finger in a particular location on a skin surface.

7. The method of claim 6 wherein the video input is embedded in a wristwatch.
